(19) United States
(12) Patent Application Publication
(10) Pub. No.: US 2010/0175904 A1
(43) Pub. Date: Jul. 15, 2010

(54) Grounding vault

(76) Inventor: Robert J. Hebert, Albuquerque, NM (US)

Correspondence Address: Stephen R. Greiner, Esquire;GREINER LAW OFFICES, Suite 300, 6701 Democracy Blvd., Bethesda, MD, 20817, US

(21) Appl. No.: 12/318,881

(22) Filed: Jan. 12, 2009

(51) Int. Cl. H01R 4/66; H02G 9/00

(52) U.S. Cl. 174/6; 174/37

(57) ABSTRACT

A grounding vault including a container with an open top. The container is formed from an electrically non-conductive material and is adapted for burial in the ground. The container is provided with an access port for the passage of grounding wires. The container is also provided with a pair of opposed slots adjacent the access port. A buss bar, formed of an electrically conductive material, is positioned so as to extend through the container. The buss bar has a pair of opposed ends for connecting to ground. The opposed ends extend respectively through the opposed slots in the container such that they project outwardly from the container. Between its opposed ends, the buss bar is provided with a number of bores for connecting the buss bar to grounding wires passing through the access port. A lid is removably positioned atop the container for closing the open top thereof.

### FIELD OF THE INVENTION

The present invention relates generally to electricity, conductors and insulators, and, more particularly, to underground structures.

### BACKGROUND OF THE INVENTION

Cell phone towers, typically being the tallest things standing in a given area, are magnets for lightening. Operators of such towers go to great lengths, therefore, to prevent lightening strikes from damaging both their towers and the electrical communications equipment connected to them. Repairs are costly and result in higher overhead. Of course, an operator cannot gain a substantial return from customers for unconnected calls to areas where lightening-damaged equipment awaits repair and reactivation. Thus, lightening strikes affect an operator's “bottom line” by increasing costs and interrupting service.

Cell phone towers are grounded so as to conduct electrical energy from a lightening strike directly to the earth. Most grounding systems include a number of electrically conductive rods that are driven into the earth at a distance from a cell phone tower and connected together by wire to form a dispersion field. The dispersion field is connected to a ground ring that is a large loop of wire that encircles the site where a cell phone tower is located. The cell phone tower, and all electrical communications equipment connected to it, are connected to the ground ring. When lightening strikes the tower, the electrical energy is passed directly through the system to the earth without harm to any equipment. Cellular communications remain unaffected.

Grounding systems utilize lots of copper that is present in the form of heavy duty wire and associated electrical connectors. Copper is well known for its relatively low resistance to electrical current flow. Unfortunately, copper is becoming more costly to acquire as commodities costs increase primarily due to worldwide shortages of hydrocarbon fuels for processing copper ore and transporting finished products. Dishonest individuals have noticed increases in the value of copper and; so, the theft of copper from the grounding systems present at cell phone tower sites has become a serious problem. Without a functioning system for grounding a cell phone tower, a tower cannot be used to complete telephone calls and must be deactivated until fixed.

Operators of cell phone towers have considered ways to eliminate copper theft and lessen costs. Some have chosen to lock electrical circuitry formed of copper in heavy-duty, alarmed cabinets to prevent theft, but installing and maintaining such cabinets has proven to be especially costly. Others have chosen to replace all above-ground copper with aluminum, but there are doubts about whether such replacements void equipment warranties if damage does result from a lightening strike. Aluminum is not as good an electrical conductor as copper.

### SUMMARY OF THE INVENTION

In light of the problems associated with the theft of copper from the operators of electrical communications systems, it is a principal object of my invention to provide below-ground storage of certain copper components used for grounding cell phone towers and ancillary electrical communications equipment. It is believed that, by placing copper out of sight and in hard to find locations, both the impulses to steal and the likelihood of copper being carried away by trespassers will be substantially reduced.

It is another object of the present invention to provide means for the below-ground storage of certain electrical components formed of copper adjacent a cell phone tower that can be retrofit into an existing tower site with minimal excavation and at low cost. Anchoring the storage means in concrete ensures a permanent installation at the site.

It is another object of the invention to provide a storage means of the type described that can be installed and used with minimal instruction.

It is an object of the invention to provide improved features and arrangements thereof in storage means for the purposes described that are lightweight in construction, inexpensive to manufacture, long lived, and fully dependable in use.

Briefly, my storage means achieves the intended objects by featuring a grounding vault that includes a container with an open top that is selectively closed by a removable lid. The container is provided with an access port for the passage of grounding wires. The container is also provided with a pair of opposed slots adjacent the access port. A buss bar extends through the container and has opposed ends that project outwardly from the slots for connecting to ground. Between its opposed ends, the buss bar is provided with a number of bores for connecting the buss bar to grounding wires passing through the access port.

The foregoing and other objects, advantages, and functional features of my grounding vault will become readily apparent upon further review of the following detailed description of the preferred embodiment shown in the accompanying drawings.

### BRIEF DESCRIPTION OF THE DRAWINGS

My grounding vault is more readily described with reference to the accompanying drawings, in which:

FIG. 1 is an exploded perspective view of a grounding vault in accordance with the present invention.

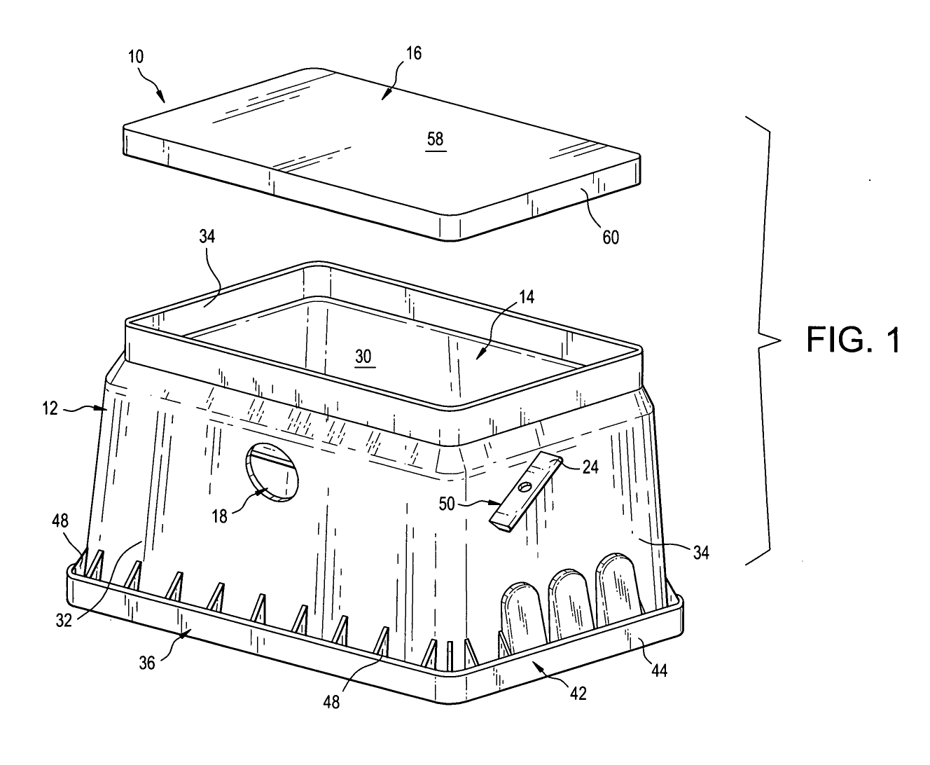

FIG. 2 is a rear elevational view of the grounding vault of FIG. 1 with portions broken away and shown anchored in the earth.

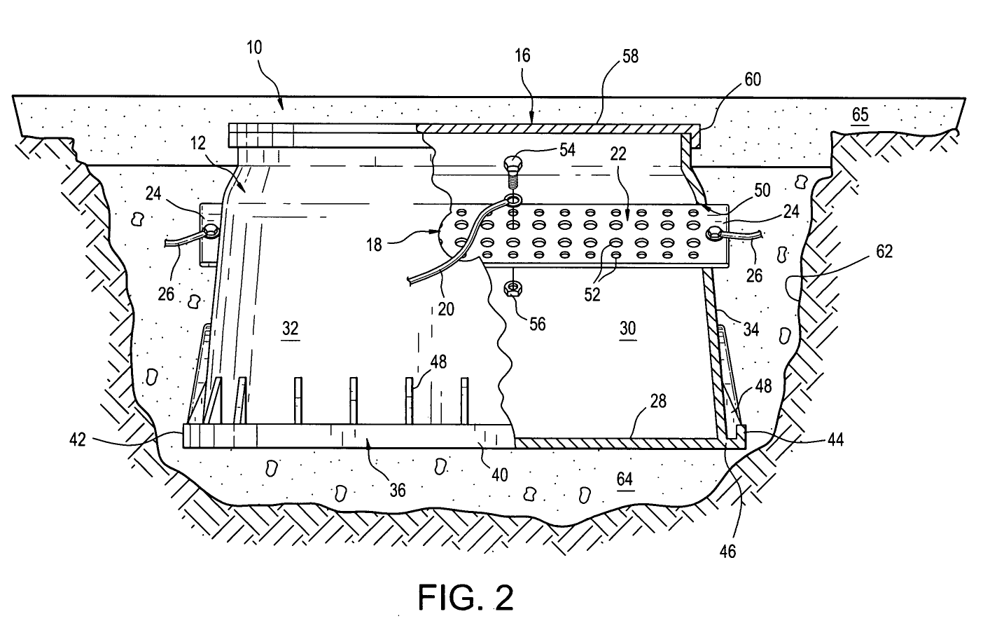

FIG. 3 is a top view of the grounding vault with the lid thereof being removed.

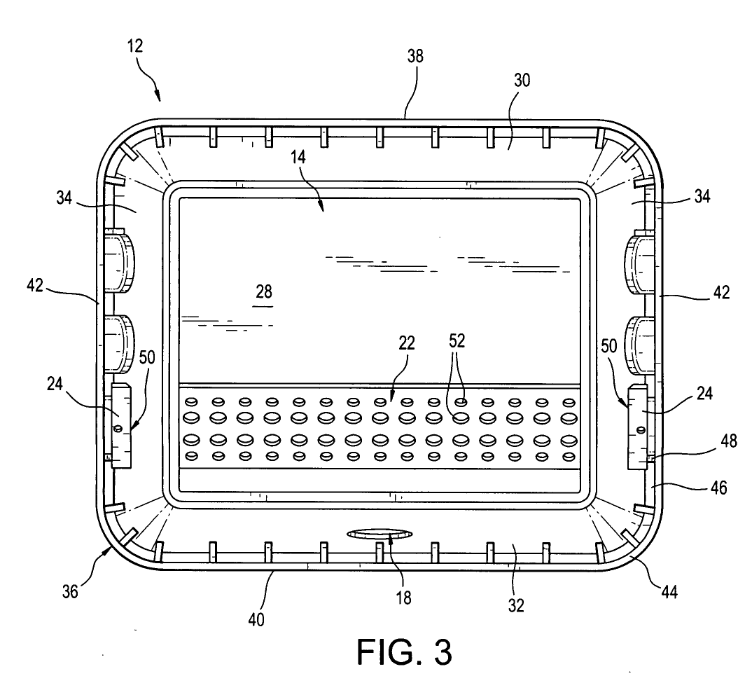

FIG. 4 is a schematic diagram showing the grounding vault as part of a grounding system for electrical communications equipment.

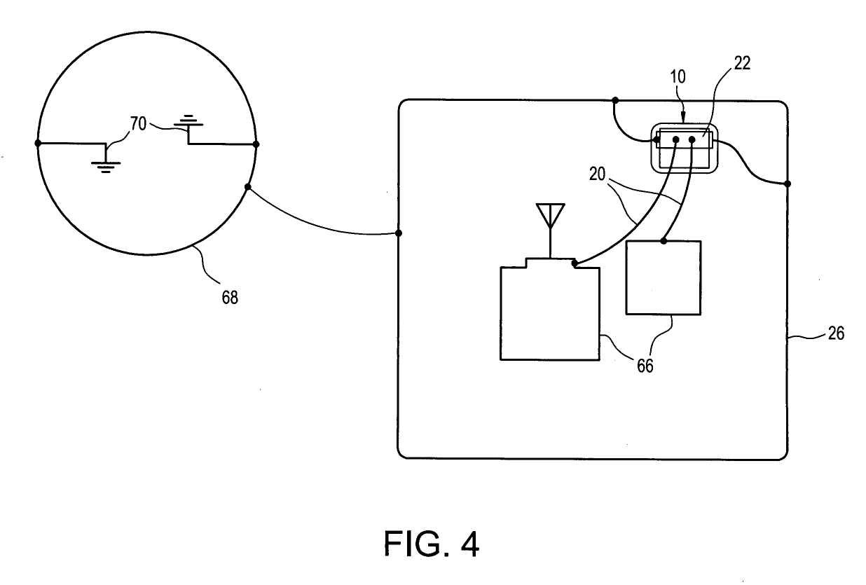

Similar reference characters denote corresponding features consistently throughout the accompanying drawings.

### DETAILED DESCRIPTION OF THE INVENTION

Referring now to the FIGS., a grounding vault in accordance with the present invention is shown at 10. Vault 10 includes a container 12 with an open top 14 that is selectively closed by a removable lid 16. Container 12 is provided with an access port 18 through which grounding wires 20 can be extended. A buss bar 22 extends through container 12 for connection of the opposed ends 24 thereof to a ground ring 26.

Open-topped container 12 is formed from a material that is electrically non-conductive, impermeable to water, durable, and weatherproof such as heavy-duty plastic. Container 12 is five-sided and has a generally pyramidal shape with a rectangular bottom wall 28 from the periphery of which a front wall 30, a back wall 32, and a pair of opposed side walls 34 extend upwardly and inwardly toward one another. When their elevations are viewed, each of walls 30, 32, and 34 appears to have a trapezoidal outline.

An anchoring flange 36 is affixed to, and projects outwardly from, the periphery of bottom wall 28. Flange 36 includes: a front portion 38 that is positioned adjacent front wall 30, a back portion 40 that is positioned adjacent back wall 32, and a pair of opposed side portions 42 respectively positioned adjacent side walls 34. Each of portions 38, 40 and 42 has an L-shaped cross section with a vertical leg 44 being affixed to, and extending upwardly from, the outer edge of a horizontal leg 46. The inner edge of each horizontal leg 46 is affixed to bottom wall 28 as shown best in FIG. **. Gussets 48 project outwardly and downwardly from walls 30, 32, and 34 to legs 44 and 46 for reinforcing portions 38, 40, and 42.

Access port 18 is provided in back wall 32. As shown, port 18 is positioned near the top of back wall 32, opposite buss bar 22, midway between side walls 34. Port 18 has a diameter that is sufficient to extend a desired number of grounding wires 20 into container 12. The exact size and positioning of port 18 is a matter of design choice and can be varied to accommodate the installation of vault 10 in a variety of environments.

Side walls 34 are provided with opposed slots 50 for snugly receiving therein the opposed ends 24 of buss bar 22. Each of slots 50 is rectangular in outline with the bottom thereof being positioned about the same distance below lid 16 as the bottom of port 18 is positioned below lid 16. Each of slots 50 is positioned in the back half of its associated side wall 34, all parts thereof being closer to back wall 32 than to front wall 30. Also, each of slots 50 is inclined at a shallow angle, say 30°, from horizontal such that it slopes downwardly and rearwardly toward back wall 32.

Buss bar 22 extends between and through slots 50 in opposed side walls 34. Buss bar 22 is formed of electrically conductive copper. In a typical vault 10, buss bar 22 may measure 24 inches (61 cm) in length, 4 inches (10 cm) in width, and 0.25 inches (6.4 mm) in height and slide into slots 50 of slightly greater dimensions in terms of width and height. Each of the opposed ends 24 of buss bar 22 projects outwardly from each of side walls 34 about 1 inch (2.5 cm). When vault 10 is set in concrete in the earth, the outward projections of buss bar 22 from container 12 effectively prevent buss bar 22 from being carried away. Vault 10 must be unburied and freed of surrounding anchoring material for buss bar 22 to be easily disengaged from container 12.

Buss bar 22 is provided with a plurality of bores 52 of various diameters for receiving bolts 54 for attaching grounding wires 20 to buss bar 22. Nuts 56 screwed onto the bottoms of bolts 54 connect wires 20 to buss bar 22. The rearward positioning and tilt of buss bar 22 in container 12 facilitate access to bolts 54.

Lid 16 is formed from the same plastic material as container 12. Lid 16 includes a rectangular top plate 58 and a lip 60 that is affixed to, and projects downwardly from, the periphery of top plate 58. Top plate 58 rests atop walls 30, 32, and 34 of container 12. Lip 60 snugly engages the outer surfaces of walls 30, 32, and 34 to retain top plate 58 in place in the event that it is inadvertently nudged to the side. Although not shown, lid 16 can be provided with bores through which threaded fasteners are extended to firmly fasten lid 16 to container 12.

The use of grounding vault 10 at a cell phone tower site is straightforward. First, a hole 62 is excavated at a desired location in the earth. Then, container 12 is positioned in the hole 62. Next, the opposed ends 24 of buss bar 22 are connected to ground ring 26 by welding or otherwise. Now, grounding wires 20 are extended into container 12 through port 18 and the free ends thereof are connected to buss bar 22 by means of nuts 56 and bolts 54. Now, lid 16 is positioned atop container 12 to close the open top 14 thereof and the hole 62 is backfilled with concrete 64 to prevent vault 10 from being moved. Finally, vault 10 is covered with a layer of gravel 65 so as to conceal it from potential thieves. The entire installation process can be performed in a few hours time for a few hundred dollars, potentially saving thousands of dollars over the life of the cell phone tower with which vault 10 is used.

If an authorized agent of the operator of the cell phone tower ever requires access to the interior of container 12, he need only push the disguising gravel away from its known location and lift lid 16. With the lid 16 removed, additional grounding wires 20 can be connected to buss bar 22. The disconnection of existing grounding wires 20 is easily accomplished as well. Regardless of the operation being performed, after it is done, lid 16 is replaced and vault 10 is reburied.

The installation of vault 10 provides a passive security system for a critical electrical component of a grounding system, namely buss bar 22. What is out of sight remains out of the minds of would-be thieves. The underground positioning of vault 10 in a sheath of concrete 64 further protects its contents from inadvertent harm caused by moving heavy equipment around cell phone tower sites.

Lightening may strike a piece of electrical communications equipment 66 connected by grounding wires 20 to buss bar 22. In such an event, the electrical current surge will pass through buss bar 22 and into ground ring 26. The surge, then, passes into the dispersion field 68 connected to ground ring 26. Dispersion field 68 terminates at one or more conductive rods 70 that defines a ground for the system. Thus, the surge passes from the rod 70 into the earth without harm to equipment 66.

While grounding vault 10 has been described with a high degree of particularity, it may be appreciated by those skilled in the field that modifications can be made to it. For example, container 12 and lid 16 can be provided in any configuration and size that a user may desire or that operating conditions may dictate. Also, the open top 14, access port 18 and slots 50 can be provided with sealing elements to prevent the infiltration of moisture, dirt, animals and insect. Thus, it is to be understood that the present invention is not limited solely to grounding vault 10, but encompasses any and all vaults within the scope of the following claims.

I claim:

1. A grounding vault, comprising:
a container with an open top, said container being formed from an electrically non-conductive material and being adapted for burial in the ground, said container being provided with an access port for the passage of grounding wires, and said container also being provided with a pair of opposed slots adjacent said access port;
a buss bar being formed from an electrically conductive material and being positioned so as to extend through said container, said buss bar having a pair of opposed ends for connecting to ground, said opposed ends extending respectively through said opposed slots in said container such that said opposed ends project outwardly from said container, and between said opposed ends said buss bar being provided with a plurality of bores for connecting to grounding wires passing through said access port; and,
a lid being removably positioned atop said container for closing the open top thereof.

2. The grounding vault according to claim 1 wherein said container further includes:
a bottom wall; and,
an anchoring flange being affixed to said bottom wall, said anchoring flange including:
a horizontal leg being affixed to the bottom of said container and extending outwardly therefrom; and,
a vertical leg being affixed to, and extending upwardly from, said horizontal leg remote from said container.

3. The grounding vault according to claim 1 wherein said container is pyramidal for preventing such from being easily pulled from the ground once buried.

4. A grounding vault, comprising:
a pyramidal container with an open top, said container including:
a rectangular, bottom wall having: a front, a back, and opposed sides;
a front wall being affixed to, and extending upwardly from the front of said bottom wall;
a back wall being affixed to, and extending upwardly from the back of said bottom wall, and said back wall being provided being with an access port for the passage of grounding wires into said container;
a pair of opposed side walls being affixed to, and extending respectively upwardly from, said opposed sides of said bottom wall, and each of said side walls being provided with a respective one of a pair of opposed slots; and,
an anchoring flange projecting outwardly and upwardly from the periphery of said bottom wall;
a buss bar having a pair of opposed ends extending respectively through said opposed slots and outwardly from said container; and,
a lid being removably positioned atop said container for selectively closing said open top.

5. The grounding vault according to claim 4 wherein said slots and said buss bar are tilted so as to slope downwardly and backwardly toward said back wall.

6. A grounding vault according to claim 4 wherein said slots and said buss bar are positioned nearer to said back wall than said front wall.
